(19) United States
(12) Patent Application Publication
(10) Pub. No.: US 2011/0101262 A1
(43) Pub. Date: May 5, 2011

(54) SURFACE-TREATED REDUCED IRON POWDER AND METHOD FOR MANUFACTURING THE SAME, AND POWDER MAGNETIC CORE

(75) Inventors: Tomofumi KURODA, Tokyo (JP); Masahito KOEDA, Tokyo (JP)

(73) Assignee: TDK CORPORATION, Tokyo (JP)

(21) Appl. No.: 12/896,252

(22) Filed: Oct. 1, 2010

(30) Foreign Application Priority Data
Oct. 30, 2009 (JP) 2009-250708

(51) Int. Cl. H01F 1/06; H01F 1/26

(52) U.S. Cl. 252/62.54; 148/101; 148/306

(57) ABSTRACT

The invention provides surface-treated reduced iron powder from which a powder magnetic core can be produced so that the powder magnetic core has small core loss and small frequency-dependence of the core loss and exhibits small core loss even when driven at high frequencies of 1 MHz or more. The surface-treated reduced iron powder is obtained by at least surface-treating reduced iron powder prepared by a reduction and slow oxidation method, and contains secondary particles formed through agglomeration of primary particles, the primary particles having an average particle diameter of 0.01-5 μm. The secondary particles have a D90% particle diameter of 20 μm or less, the surface of the primary particles is at least in part coated with an insulating layer containing iron phosphate, and the phosphorus content is 500-10000 ppm.

### CROSS-REFERENCES TO RELATED APPLICATIONS

The present application relates to and claims priority from Japanese Patent Application No. 2009-250708, filed on Oct. 30, 2009, the entire disclosure of which is incorporated herein by reference.

### BACKGROUND

1. Field of the Invention

The present invention relates to surface-treated reduced iron powder and a method for manufacturing the same, and a powder magnetic core.

2. Description of Related Art

Powder magnetic cores have been widely used for magnetic cores provided in inductors, etc. The properties required for powder magnetic cores are high electric resistance and small core loss (magnetic core loss), and in order to obtain powder magnetic cores having such properties, various attempts have been made, for example, using, as the powder magnetic core material, magnetic metal powder such as alloy powder of FeSi-type, FeNi-type, etc., produced by an atomizing method and pure iron powder (high-purity iron powder) produced by a carbonyl method.

In recent years, smaller and higher-power electronic devices have been developed, and various components have been more highly integrated while the processing speeds of such components have been increasing. Along with the above, a smaller size and higher current have been required for power source lines for supplying electric power. For example, for power inductors used in a power source, etc., those exhibiting a smaller decrease of inductance when a direct current is superimposed have been demanded. In order to respond to that demand, magnetic materials having high saturation magnetization, e.g., pure iron powder (high-purity iron powder), have been widely used for the material of powder magnetic cores.

Meanwhile, since inductors, etc., can be downsized by driving the power circuit at high frequencies, development of magnetic materials that exhibit small magnetic core loss (core loss) in the range of high frequencies has been demanded. In order to respond to high-frequency driving, for example, at several MHz, reducing the size of the magnetic materials is considered effective.

Regarding the techniques for reducing the size of the magnetic materials, for example, Japanese Examined Patent Publication No. H06-048389 describes obtaining reduced iron powder for use in magnetic toners, having a particle diameter of 0.1-5 μm, by reducing hematite or magnetite and thereafter oxidizing the surface (see Patent Document 1).

Also, Japanese Patent No. 4158768 describes heating hematite powder in reducing gas and stopping the reduction of the hematite powder in the middle so as to make the powder contain magnetite, thereby obtaining magnetite-iron composite powder for use in radio wave absorbents, the composite powder having an average primary particle diameter of 0.01-10 μm (see Patent Document 2).

Also, Japanese Patent No. 4171002 describes reducing iron oxide containing magnetite and a specific amount of chrome in a reducing atmosphere and subsequently carrying out slow oxidation in an oxidizing atmosphere, thereby obtaining magnetite-iron composite powder for use in powder magnetic cores, the composite powder having an average primary particle diameter of 0.7-3.0 μm (see Patent Document 3).

In addition, Patent Documents 2 and 3 describe producing a powder magnetic core by adding insulating resin to the magnetite-iron composite powder and thereafter pressing the composite powder.
[Patent Document 1] Japanese Examined Patent Publication No. H06-048389
[Patent Document 2] Japanese Patent No. 4158768
[Patent Document 3] Japanese Patent No. 4171002

### SUMMARY

The method described in Patent Document 1 is to obtain fine reduced iron powder using a so-called reduction and slow oxidation method. By this method, reduced iron powder in which the average particle diameter of the primary particles is from several micrometers down to the submicron range can be obtained stably. However, when the inventors of the present invention produced a powder magnetic core using reduced iron powder obtained according to the method described in Patent Document 1, the produced powder magnetic core had a problem of exhibiting large core loss, in particular, exhibiting extremely large core loss when driven at a high frequency of 1 MHz or more.

The methods disclosed in Patent Documents 2 and 3 also enable the stable production of reduced iron powder having a primary particle average diameter of several micrometers down to the submicron range; however, as with Patent Document 1 above, there are problems in that when producing a powder magnetic core from such reduced iron powder, the powder magnetic core exhibits large core loss, and in particular, exhibits extremely large core loss when driven at a high frequency of 1 MHz or more.

As stated above, although reduced iron powder obtained, for example, by reducing iron oxide is fine iron powder and has been expected to be applied to powder magnetic cores, a technique that sufficiently allows such application has not yet been found.

The invention has been made in view of the above problems, and an object of the invention is to provide: surface-treated reduced iron powder from which a powder magnetic core can be produced so that the powder magnetic core has comparatively small core loss and small frequency-dependence of the core loss and exhibits small core loss even when driven at high frequencies of 1 MHz or more; a method for manufacturing the above surface-treated reduced iron powder; and a powder magnetic core having small core loss and small frequency-dependence of the core loss.

In order to solve the above problems, as a result of extensive studies, the inventors of the invention found that, in reduced iron powder having an average primary particle diameter of several micrometers down to the submicron range, not only the average primary particle diameter, but also the agglomeration state and the surface state of the primary particles have correlations to the core loss of the obtained powder magnetic core and the frequency-dependence of the core loss, thereby completing the invention.

Namely, the invention provides surface-treated reduced iron powder obtained by at least surface-treating reduced iron powder prepared by a reduction and slow oxidation method, the surface-treated reduced iron powder containing secondary particles formed through agglomeration of primary particles having an average particle diameter of 0.01-5 μm, wherein: the secondary particles have a D90% particle diameter of 20 μm or less; the surface of the primary particles is at least in part coated with an insulating layer comprising iron phosphate; and a phosphorus content is 500-10000 ppm.

The “reduced iron powder” used herein not only refers to iron powder obtained by reducing iron oxide, but also encompasses iron powder obtained by reducing iron oxide and thereafter carrying out slow oxidation. Also, the “primary particles” used herein mean particles as the smallest units contained in the powder; whereas the “secondary particles” used herein mean particles formed of the primary particles agglomerating due to an intermolecular force, etc., or connecting by moderate necking. Note that since the surface-treated reduced iron powder normally exists in the form of secondary particles, the particle size distribution graph of the surface-treated reduced iron powder shows the distribution of the secondary particles. Also note that the particle diameter means, unless otherwise specified, a median diameter in a cumulative volumetric distribution.

When the inventors of the invention measured the properties of powder magnetic cores produced from the surface-treated reduced iron powder having the above-described configuration, the inventors found that the powder magnetic cores exhibited smaller core loss than the conventional products when driven at low frequencies of about 50-200 kHz, and also exhibited extremely small core loss when driven at high frequencies of 1 MHz or more. Although the details of the operational mechanism of the above effects are not yet known, the mechanism can be presumed to be, for example, as follows.

The reduced iron powder obtained by the above-mentioned conventional techniques is normally constituted by secondary particles each having a spongy structure formed of fine primary particles agglomerating (connecting) together. According to the knowledge of the inventors of the invention, an eddy current can flow within the secondary particles, and it seems that since the reduced iron powder obtained by the above-mentioned conventional techniques has a large secondary particle D90% particle diameter of 100 μm or more, it causes relatively large eddy current loss and thus exhibits large core loss.

In the above-mentioned conventional techniques, some attempts have been made, including slowly oxidizing the surface of the secondary particles to form an insulating layer of magnetite, etc., and further adding an insulating resin as required. The above attempts are considered as blocking the path of eddy current and contributing to the reduction of eddy current loss. However, according to the knowledge of the inventors of the invention, it seems that, in the above-mentioned conventional techniques, it is actually impossible to reduce eddy current loss to a sufficient level for reasons such as: magnetite having low electric resistivity and not having sufficient insulating properties, and thus making it difficult to reduce eddy current loss to a sufficiently small value; an insulating resin layer not being easily formed on the interfaces between the agglomerating primary particles; and the secondary particles each having a spongy structure formed of the fine primary particles connecting together, which results in the surface area relatively larger than that of carbonyl iron powder or atomized powder having a dense structure inside.

On the other hand, although the surface-treated reduced iron powder of the above configuration contains primary particles having an average particle diameter similar to those in the conventional techniques, secondary particles, which are formed of the primary particles agglomerating together, have a relatively small D90% particle diameter, and furthermore, at least part of the surface of the primary particles is coated with an insulating layer containing a specific amount of iron phosphate relative to (the iron oxide layer of) magnetite, etc. In other words, as explained later, in the surface-treated reduced iron powder of the above configuration, each iron particle is well insulated from the others due to the insulating layer containing iron phosphate which has excellent insulating properties, and furthermore, the primary particles having a small particle diameter and the secondary particles each having a spongy structure make the path of eddy current short, in other words, the path of eddy current is effectively blocked. It is believed that a powder magnetic core produced using the above surface-treated reduced iron powder can thus well reduce eddy current loss, and consequently exhibit greatly reduced core loss in the range of high frequencies as well as low frequencies. Note that the presence of iron phosphate on the surface of the particles can be observed, for example, by detecting P, O and Fe in the STEM-EDS analysis, etc., using an energy dispersive X-ray analyzer.

In the meantime, regarding the conventional atomized powder or carbonyl iron powder, etc., methods are known for forming an insulating layer on the surface of the secondary particles thereof by surface treatment using phosphoric acid. However, an insulating layer obtained by surface treatment using phosphoric acid, e.g., an insulating layer of iron phosphate coating, is hard and has low plasticity, and thus, when forming a powder magnetic core by pressing, the above insulating layer cannot follow the plastic deformation of the secondary particles, and is destroyed. Accordingly, in the conventional atomized powder or carbonyl iron powder, etc., conduction is likely to be created between the metal particles, and the path of eddy current is likely to be long. As for powder magnetic cores used for inductors, in order to maintain the insulating properties, resin has thus been commonly used as the insulating materials since resin can follow the deformation of the metal particles.

On the other hand, in the surface-treated reduced iron powder of the above configuration, reduced iron powder prepared by a reduction and slow oxidation method is used, and this reduced iron powder contains secondary particles each having a spongy structure formed through agglomeration of primary particles having an average particle diameter of 0.01-5 μm. Accordingly, when forming a powder magnetic core by pressing, the primary particles themselves do not deform so much, whereas the secondary particles (more specifically, the spongy structure thereof), which are formed of the primary particles agglomerating (connecting) together, are likely to deform. More specifically, in the surface-treated reduced iron powder of the above configuration, it is believed that the compression of the spaces between the secondary particles occupies a larger part than the deformation of the primary particles themselves. Accordingly, even if the secondary particles deform and the primary particles contact each other during the pressing, since the secondary particles each have a spongy structure as stated above, the insulating layer on the surface of the primary particles can be maintained at a higher probability than the case where atomized powder or carbonyl iron powder, etc., is used, and contact between exposed iron particles is unlikely to happen. As a result, conduction created through contact between iron particles can be reduced, and the path of eddy current is blocked and consequently becomes short. It is believed that a powder magnetic core produced using the above surface-treated reduced iron powder can thus well reduce eddy current loss, and consequently exhibit greatly reduced core loss in the range of high frequencies as well as low frequencies. Note that the effects are not limited to the above.

Instead of adopting the above configuration, forming the insulating layer of magnetite, etc., in the conventional techniques excessively thick could be one option; however, this is considered unpractical for reasons such as relatively low electric resistivity of magnetite, and concerns that the existence of a ferromagnetic layer having different magnetic properties from those of the primary layer of iron might increase hysteresis loss. On the other hand, a surface coating formed by phosphoric treatment, e.g., an iron phosphate coating, does not have ferromagnetic properties and thus does not produce so much adverse magnetic effects, and furthermore, rustproof effects can be expected because of being a stable compound. In those respects, the surface-treated reduced iron powder of the above configuration can be said to be advantageous.

Also, instead of adopting the above configuration, increasing the amount of insulating resin added in the conventional techniques to an excessively large amount could also be one option; however, this as well is considered unpractical because an increase of non-magnetic components could induce a decrease of inductance.

In the surface-treated reduced iron powder of the above configuration, it is required that the surface of the primary particles be at least in part coated with an insulating layer comprising iron phosphate. Since the insulating layer comprising iron phosphate has excellent insulating properties and is relatively stable, the surface-treated reduced iron powder can be handled in the air during the production; in other words, the handleability and productivity of the surface-treated reduced iron powder can be increased. Also, the insulating layer may partly contain iron oxide (e.g., FeO, Fe₂O₃, Fe₃O₄). By using an insulating layer containing iron phosphate and iron oxide, the insulating properties, handleability and productivity can be even further increased.

Also, the surface-treated reduced iron powder of the above configuration is preferably obtained by disintegrating the reduced iron powder and surface-treating the reduced iron powder using phosphoric acid. By these processes, the surface-treated reduced iron powder can be produced stably at relatively low costs, and thus its productivity and cost-effectiveness can be increased.

Also, it is preferable that the surface-treated reduced iron powder of the above configuration further comprises insulating resin. With this, the insulating properties between the iron particles can be increased, and furthermore, the path of eddy current is blocked, and eddy current loss can be further reduced. In addition, increased compactibility and excellent practicality can be obtained.

The invention also provides a powder magnetic core which is effectively obtained by using the above surface-treated reduced iron powder of the invention. The powder magnetic core is obtained by pressing the above surface-treated reduced iron powder.

The invention also provides a method for manufacturing surface-treated reduced iron powder, whereby the above surface-treated reduced iron powder of the invention can be effectively produced. The method includes the steps of: preparing reduced iron powder by a reduction and slow oxidation method, the reduced iron powder comprising primary particles having an average particle diameter of 0.01-5 μm; disintegrating the reduced iron powder; and surface-treating the reduced iron powder with 0.15-4.00% by weight of phosphoric acid relative to the weight of the reduced iron powder. According to this method, disintegration (reducing the diameter) of the secondary particles as well as insulative coating of the primary and secondary particles can be performed effectively. Also, as a result of the surface-treatment with phosphoric acid, the oxide layer on the surface is removed, and instead, a stable surface layer containing as the major components phosphorus, oxygen and iron is formed. Accordingly, the surface-treated reduced iron powder that allows the production of a powder magnetic core exhibiting well reduced core loss in the range of high frequencies as well as low frequencies can be produced in a simple way at low costs.

In the above, it is preferable that the disintegrating step and the surface-treating step using phosphoric acid are carried out at the same time, or the surface-treating step using phosphoric acid is carried out after the disintegrating step. With this, disintegration of the secondary particles as well as insulative coating of the primary and secondary particles can be performed at high efficiency, and accordingly, the surface-treated reduced iron powder that allows the production of a powder magnetic core exhibiting well reduced core loss in the range of high frequencies as well as low frequencies can be produced in a simple way at low costs. Furthermore, the productivity and cost-effectiveness can be even further improved.

Also, in the step of preparing reduced iron powder, it is preferable that the reduced iron powder is obtained by carrying out reduction in a reducing atmosphere and thereafter carrying out slow oxidation in an oxidizing atmosphere. With this method, reduced iron powder that contains primary particles having an average particle diameter of 0.01-5 μm and that can be handled in the air, can be produced in a simple way at low costs, and accordingly, the productivity and cost-effectiveness can be even further increased.

Also, in the disintegrating step, it is preferable that the reduced iron powder is disintegrated using media, each having a weight of 6 g or less. With this, disintegration can be achieved without deforming the primary particles or degrading the magnetic properties due to distortion, and accordingly, the surface-treated reduced iron powder that allows the production of a powder magnetic core exhibiting well reduced core loss in the range of high frequencies as well as low frequencies can be produced in a simple way at low costs. Furthermore, the productivity and cost-effectiveness can be even further improved.

It is also preferable that the method further includes the step of adding insulating resin to the reduced iron powder after the surface-treatment. With this, the insulating properties can be increased, and the path of eddy current is blocked and eddy current loss can be further reduced, and accordingly, the surface-treated reduced iron powder that allows the production of a powder magnetic core exhibiting well reduced core loss in the range of high frequencies as well as low frequencies can be produced in a simple way at low costs. Furthermore, increased compactability and excellent practicality can be obtained.

Surface-treated reduced iron powder according to another aspect of the invention is effectively produced by the method for manufacturing the surface-treated reduced iron powder of the invention, the surface-treated reduced iron powder being obtained by: disintegrating reduced iron powder prepared by a reduction and slow oxidation method; and surface-treating the reduced iron powder using phosphoric acid, and comprising secondary particles formed through agglomeration of primary particles having an average particle diameter of 0.01-5 μm, wherein: the secondary particles have a D90% particle diameter of 20 μm or less; and a phosphorus content is 500-10000 ppm. It is preferable that the secondary particles include on the surface thereof P, O and Fe. The presence of P, O and Fe on the surface of the particles can be detected, for example, by STEM-EDS analysis using an energy dispersive X-ray analyzer.

The invention provides: a powder magnetic core that exhibits sufficiently reduced core loss in the range of high frequencies as well as low frequencies and is applicable to high frequencies of 1 MHz or higher; surface-treated reduced iron powder that allows such a powder magnetic core to be produced with ease; and a method for manufacturing such surface-treated reduced iron powder in a simple way at low costs. Also, since the invention is applicable to higher driving frequencies, the invention can achieve downsizing of inductors, etc.

### BRIEF DESCRIPTION OF THE DRAWINGS

FIG. 1 is a schematic illustration of surface-treated reduced iron powder according to an embodiment of the invention, conceptually showing a secondary particle and the agglomeration state of primary particles.

FIG. 2 is a flowchart showing a method for manufacturing surface-treated reduced iron powder and a method for manufacturing a powder magnetic core according to an embodiment of the invention.

FIG. 3 is an SEM photograph of surface-treated reduced iron powder of Example 1.

FIG. 4 is an SEM photograph of surface-treated reduced iron powder of Example 1.

FIG. 5 shows STEM-EDS Fe-, P-, O- and C-concentration profiles of reduced iron powder of Example 1.

### DETAILED DESCRIPTION OF PREFERRED EMBODIMENTS

An embodiment of the invention will be described below. The below embodiment is just an example for describing the invention, and the invention is not limited to the embodiment. In the drawings, the same components are given the same reference numerals, and any repetitive description will be omitted. The positional relationship, such as top and bottom, left and right, etc., is as shown in the drawings unless otherwise specified. The dimensional ratios are not limited to those shown in the drawings.

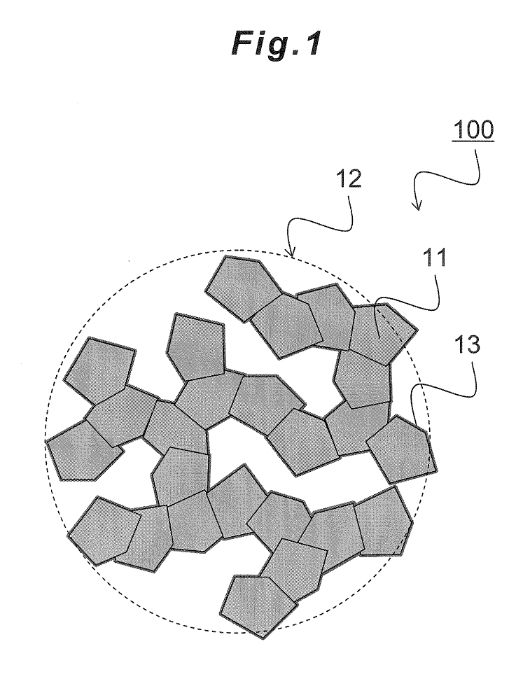

FIG. 1 is a schematic illustration of surface-treated reduced iron powder according to this embodiment, conceptually showing a secondary particle and the agglomeration state of primary particles.

Surface-treated reduced iron powder 100 is obtained by at least surface-treating reduced iron powder prepared by a reduction and slow oxidation method, and has secondary particles 12 formed through agglomeration or connecting of primary particles 11 having an average particle diameter of 0.01-5 μm, preferably 3 μm or less, and more preferably 2 μm, the secondary particles 12 having a D90% particle diameter of 20 μm or less, preferably 10 μm or less, and more preferably 7 μm. The surface of the primary particles 11 is at least in part coated with an insulating layer 13. The insulating layer 13 contains at least iron phosphate, and the phosphorus content relative to the total amount of the surface-treated reduced iron powder 100 is 500-10000 ppm, preferably 8000 ppm or less, and more preferably 6000 ppm or less. As shown in the illustration, the secondary particle 12 has a spongy structure formed by multiple primary particles 11 agglomerating or connecting together. The following is a detailed explanation of the surface-treated reduced iron powder 100 of this embodiment, in relation to a method for manufacturing surface-treated reduced iron powder and a method for manufacturing a powder magnetic core according to this embodiment.

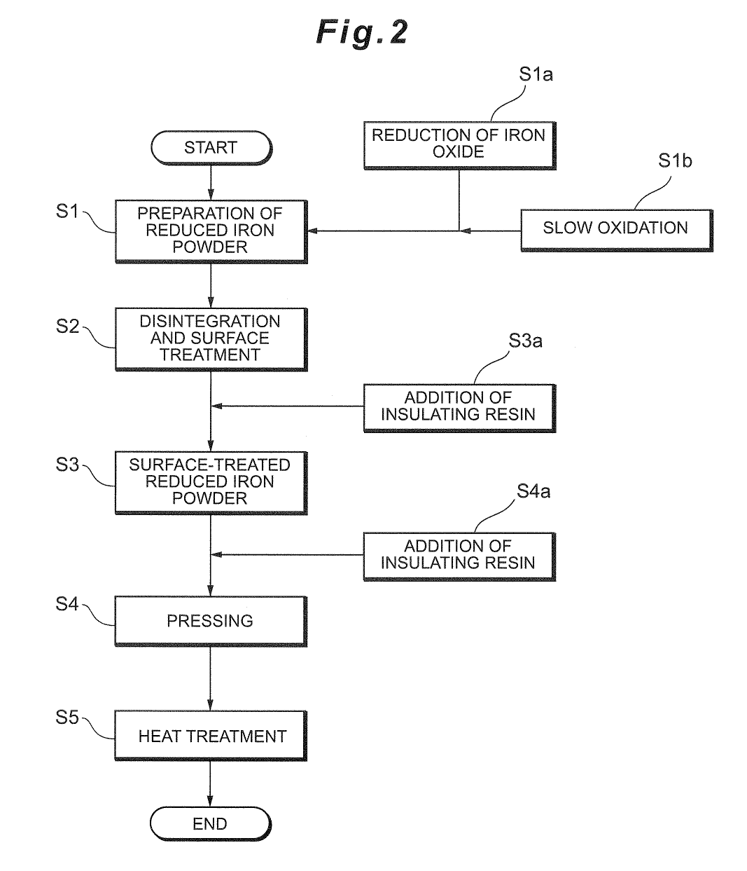

FIG. 2 is a flowchart showing the method for manufacturing surface-treated reduced iron powder and the method for manufacturing a powder magnetic core according to this embodiment.

The surface-treated reduced iron powder of this embodiment can be produced by the steps of preparing reduced iron powder by a reduction and slow oxidation method (S1); and disintegrating the prepared reduced iron powder and surface-treating it with phosphoric acid (S2). The surface-treated reduced iron powder of this embodiment may contain insulating resin if necessary, and in that case, the step of adding insulating resin (S3a) is performed after steps S1 and S2 above.

Also, the powder magnetic core of this embodiment can be produced by pressing the above-obtained surface-treated reduced iron powder and thereafter carrying out heat treatment (S4-S5). In the powder magnetic core of this embodiment, insulating resin may be added in the pressing, and in that case, the step of adding insulating resin (S4a) is performed before step S4.

In the step of preparing reduced iron powder (S1), reduced iron powder containing primary particles having an average particle diameter of 0.01-5 μm is prepared. Such reduced iron powder containing primary particles having an average particle diameter of 0.01-5 μm is prepared in this embodiment by a reduction and slow oxidation method, so that a powder magnetic core exhibiting adequately reduced core loss in the range of high frequencies as well as low frequencies can be obtained. The reduction and slow oxidation method is to obtain finely-formed reduced iron powder having a stable passivation layer (iron oxide layer) formed on its surface (the surface is slightly oxidized) by reducing iron oxide (S1a) and then oxidizing the surface slowly and moderately (S1b).

Known iron oxides may be used as the raw material iron oxide of the reduced iron powder. Specific examples include, without limitation, iron oxides (including iron-containing hydroxides) such as hematite, maghematite, magnetite, wüstite, berthollide, goethite, akaganéite and lepidocrocite. These may be used alone, and may also be used in combination of two or more types. Of these, hematite is preferably used as the raw material iron oxide of the reduced iron powder, since hematite can be recovered from the acid used for acid cleaning performed before rolling of steel strips and such hematite products are readily available at an inexpensive price.

The raw material iron oxide of the reduced iron powder is in the form of fine particles. The primary particle diameter of the raw material iron oxide is preferably smaller than the primary particle diameter of the desired surface-treated reduced iron powder. In the preparation of reduced iron powder by a reduction and slow oxidation method, primary particles can be grown to have a larger diameter by setting the reduction conditions as required; however, it tends to be difficult to obtain reduced iron powder having a relatively small particle diameter from iron oxide powder having a relatively large particle diameter.

There are no particular limitations on step S1a of reducing iron oxide, as long as reduction is carried out according to a reduction and slow oxidation method under known conditions. The performance of the furnace used, and the reaction system such as a fluidized, fluidized-bed, rotary or fixed-bed system may be determined arbitrarily according to, for example, the amount of iron oxide to be treated. Generally, reduction is performed in a fixed-bed furnace or a rotary furnace such that about 20-100 g of iron oxide is treated in a low-oxygen reducing gas atmosphere at a reduction temperature of about 200-650° C. for about 1-6 hours. In general, if the oxygen partial pressure exceeds 10%, oxidation is likely to proceed rapidly to the inside of the particles, resulting in reduction not proceeding sufficiently. Also, if the reduction temperature is lower than 200° C., the reaction time would be longer or reduction would not proceed sufficiently. On the other hand, if the temperature exceeds 700° C., sintering is likely to occur, which would make the particle diameter larger. Accordingly, the reduction temperature is preferably 400-650° C. Examples of the reducing gas that may be used include CO, H₂S, SO₂ and H₂, and in particular, H₂ is used preferably.

There are no particular limitations on step S1b of slowly and moderately oxidizing the surface of the iron powder obtained by the above reduction, as long as oxidation is performed according to a reduction and slow oxidation method under known conditions and the surface is moderately oxidized so that the oxidation does not proceed to the inside of the iron powder. The treatment temperature and time, oxygen concentration, etc., may be determined arbitrarily according to, for example, the amount of iron oxide to be treated. Generally, about 20-100 g of iron oxide is treated in a furnace in an oxygen-containing atmosphere with an oxygen partial pressure of about 1-5%, at a temperature of about 20-100° C. for about 5 minutes to one hour.

One example of the treatment conditions preferably employed in this embodiment is as follows: placing raw material iron oxide powder in a fixed-bed or rotary furnace; reducing the iron oxide powder at about 500-600° C. for about 3-5 hours while introducing dry hydrogen gas, and thereafter cooling the resulting iron powder to room temperature; and slowly oxidizing the resulting iron powder in an inert gas atmosphere with an oxygen partial pressure of about 1-3%, at a temperature of about 30-80° C. for about 5-30 minutes.

Next, the reduced iron powder prepared according to a reduction and slow oxidation method as above, which contains primary particles having an average particle diameter of 0.01-5 μm, is disintegrated, and surface-treated with phosphoric acid (S2). As a result, the surface-treated reduced iron powder of this embodiment can be obtained (S3).

In the disintegration treatment, energy is applied from the outside to the reduced iron powder prepared by a reduction and slow oxidation method as above. With this application, a shear force is applied to the secondary particles to dissolve the agglomeration of the primary particles, and as a result, reduced iron powder in which the D90% particle diameter of the secondary particles is reduced to 20 μm or less can be obtained.

There are no particular limitations on the method for the disintegration treatment, as long as the disintegration can dissolve the agglomeration of the primary particles and reduce the secondary particle diameter. For example, ball mills and bead mills, etc., which use media, as well as kneaders, mixers, stirrers and dispersers including those called a planetary mixer, an open kneader, a Henschel mixer and a homogenizer, may be used as the disintegration apparatus, regardless of what they are called. By using these apparatuses, the secondary particles are caused to collide with each other and also collide with the media as well as the inner wall of the reactor, etc., and accordingly, a shear force is applied to the secondary particles and the agglomeration of the primary particles can be dissolved.

The disintegration treatment is preferably performed in a state where a solvent has been added to the reduced iron powder. Since the primary particles are coated with the added solvent, the primary particles can be prevented from agglomerating again to form a secondary particle. Also, since it becomes easy to apply a strong shear force to the secondary particles, disintegration can be carried out at high efficiency, and furthermore, the reduced iron powder can be prevented from being oxidized by the air. Examples of the solvent that may be used include, without limitation, oils such as mineral oil, synthetic oil or vegetable oil, and organic solvents such as acetone or alcohol.

Also, the disintegration treatment is preferably carried out in an inert gas atmosphere, e.g., nitrogen atmosphere, with an oxygen concentration of 500 ppm or lower, so as to prevent the reduced iron powder from being oxidized by the air.

One example of the disintegration treatment preferably employed in this embodiment is using a disintegration apparatus utilizing media and stirring and mixing the reduced iron powder with a solvent and the media in an inert gas atmosphere. Examples of the media include, without limitation, carbon steel balls, chrome steel balls, zirconia balls, alumina balls and silicon nitride balls. If the weight of the media is too large, plastic deformation (flattening) of the primary particles in the reduced iron powder proceeds, which would increase hysteresis loss. Thus, the weight of one medium is preferably 6 g or less, and more preferably 1 g or less.

The time of the disintegration treatment is not particularly limited, and may arbitrarily be set according to, for example, the apparatus used, the use or non-use of media, the weight and shape of the media, stirring blades, etc., the rotation speed and the rotation torque. Taking productivity and costs into consideration, the time is preferably about 10 minutes to 10 hours.

In the surface treatment using phosphoric acid, a specific amount of phosphoric acid is applied to the reduced iron powder prepared by a reduction and slow oxidation method as above. With this application, iron oxide that has been formed on the surface of the reduced iron powder particles by slow oxidation, can be dissolved or removed, and iron phosphate, which has excellent insulating properties, is formed on the surface of the particles. Herein, “phosphoric acid” refers to orthophosphoric acid (H₃PO₄), which is an inorganic acid.

In the above surface treatment, the amount of phosphoric acid added needs to be 0.15-4.00% by weight relative to the weight of the reduced iron powder. This phosphoric acid amount is the weight ratio calculated based on an 89% orthophosphoric acid (H₃PO₄) aqueous solution. If the phosphoric acid amount is less than 0.15% by weight relative to the weight of the reduced iron powder, the resulting insulating layer would not have sufficient thickness, or would be in an uneven form, which would make it impossible to bring about the sufficient effect of reducing eddy current, and furthermore, a powder magnetic core obtained using such reduced iron powder would have large core loss at high frequencies exceeding 1 MHz, and the core loss would be largely dependent on frequency. Thus, such a small amount is not suitable. On the other hand, if the phosphoric acid amount exceeds 4.0% relative to the weight of the reduced iron powder, not only the surface oxidation layer but also the internal metal iron of the reduced iron powder would be dissolved, which would produce adverse magnetic effects to increase the hysteresis loss, and would also increase the core loss at low frequencies of about 50-200 kHz. Thus, such a large amount is not suitable.

The timing of carrying out the disintegration treatment and the surface treatment using phosphoric acid is not particularly limited, and any of the following:

(a) the disintegration treatment is carried out first, and the surface treatment using phosphoric acid is carried out thereafter;

(b) the disintegration treatment and the surface treatment using phosphoric acid are carried out at the same time; and

(c) the surface treatment using phosphoric acid is carried out first, and the disintegration treatment is carried out thereafter,

may be employed. Of these, (a) and (b) are preferable because the core loss of the obtained powder magnetic core, and the frequency-dependence of the core loss can be even further reduced.

When carrying out the disintegration treatment and the surface treatment using phosphoric acid at the same time as in (b) above, these treatments can be performed in a simple way by adding a solvent and a specific amount of phosphoric acid to the reduced iron powder and stirring and combining the resulting mixture using disintegration apparatus.

The surface-treated reduced iron powder of this embodiment obtained as above has secondary particles formed through agglomeration of the primary particles having an average particle diameter of 0.01-5 μm, and the D90% particle diameter of the secondary particles is 20 μm or less, and at least part of the surface of the primary particles is coated with an insulating layer containing iron phosphate.

The surface-treated reduced iron powder of this embodiment needs to have a phosphorus content of 500-10000 ppm. In the surface-treated reduced iron powder of this embodiment, which has been treated with a specific amount of phosphoric acid as stated above, the majority of the added phosphoric acid remains in the surface-treated reduced iron powder, and the surface of the reduced iron powder is coated with phosphorus or phosphorus compounds which act as an insulating layer. If the phosphorus content is less than 500 ppm, the thickness of the insulating layer would probably be insufficient, or the insulating layer would probably be in an uneven form, which would make it impossible to bring about the sufficient effect of reducing eddy current, and furthermore, a powder magnetic core obtained using such reduced iron powder would have large core loss at high frequencies exceeding 1 MHz, and the core loss would be largely dependent on frequency. Thus, such a small content is not suitable. On the other hand, if the phosphorus content exceeds 10000 ppm, not only the surface oxidation layer but also the internal metal iron of the reduced iron powder would probably be dissolved, which would produce adverse magnetic effects to increase the hysteresis loss, and would also increase the core loss at low frequencies of about 50-200 kHz. Thus, such a large content is not suitable. The phosphorus content is preferably 600-6000 ppm, and more preferably 1000-5000 ppm.

The insulating layer formed in the surface-treated reduced iron powder by the surface treatment using phosphoric acid is a layer containing at least iron phosphate, but it may further contain iron oxide (e.g., FeO, Fe₂O₃, Fe₃O₄. The insulating layer has a thickness of preferably 3-100 nm, more preferably 5-70 nm, and even more preferably 10-50 nm.

The surface-treated reduced iron powder of this embodiment may contain insulating resin. By coating all or part of the surface of the surface-treated reduced iron powder with insulating resin, the particles can have increased insulating properties between them, and furthermore, when forming a powder magnetic core, improved compactability can be obtained. Such insulating resin may arbitrarily be selected according to the required properties, and specific examples include various types of organic polymeric resins such as silicone resin, phenol resin, acrylic resin and epoxy resin. These may be used alone, or in combination of two or more types. In addition, the surface-treated reduced iron powder of this embodiment may contain known curing agents or cross-linking agents as required.

The surface-treated reduced iron powder of this embodiment may further contain, as required, additives known in the art, such as inorganic materials including SiO₂ and Al₂O₃, lubricants, and forming assistants.

The powder magnetic core of this embodiment can be produced by pressing the surface-treated reduced iron powder of this embodiment and heating it thereafter (S4-S5). As stated before, insulating resin may be added in the pressing (S4a). Other than using the surface-treated reduced iron powder of this embodiment as a core material, the powder magnetic core of this embodiment can be produced by a conventionally known method.

Examples of the insulating resin that may be added include, without limitation, various types of organic polymeric resins such as silicone resin, phenol resin, acrylic resin and epoxy resin. These may be used alone, or in combination of two or more types. Known curing agents, cross-linking agents, lubricants, etc., may also be added, as required.

Although the amount of the insulating resin added is not particularly limited, an increase of the insulating resin, which is a non-magnetic component, would cause a decrease of inductance, and in this respect, the amount of the insulating resin is preferably 0.1-5% by weight relative to the weight of the reduced iron powder used.

The surface-treated reduced iron powder is preferably mixed with the insulating resin, etc., using a stirrer/mixer such as a pressure kneader or a ball mill. The mixing is preferably performed at room temperature for 20-60 minutes, so that the surface-treated reduced iron powder coated with the insulating resin can easily be obtained. In particular, the mixing is preferably performed in the presence of the above-mentioned organic solvent, so as to improve the wetting properties. More specifically, the mixing is preferably performed at room temperature for 20-60 minutes, the resulting mixture is preferably dried at a temperature of about 50-100° C. for 10 minutes to 10 hours, the organic solvent is thereafter evaporated or removed, and as a result, the surface-treated reduced iron powder coated with the insulating resin is obtained.

In the pressing step, a mold of a pressing machine is filled with the above obtained surface-treated reduced iron powder, and after that, the surface-treated reduced iron powder is compressed by applying pressure, thereby obtaining a compact. The conditions of the above compression are not particularly limited, and may arbitrarily be determined according to, for example, the bulk density and viscosity of the surface-treated reduced iron powder, and the shape, size and density of the desired powder magnetic core. For example, normally, a pressure of about 4-12 tonf/cm², and preferably about 6-8 tonf/cm², is applied, and the time of holding the surface-treated reduced iron powder under the maximum pressure is about 0.1 second to 1 minute.

In the heating step, the compact obtained above is held, for example, at a temperature of 150-300° C. for about 15-120 minutes. As a result, the insulating resin inside the compact is cured, thereby obtaining a powder magnetic core (green compact).

After the heating step, the step of applying rust-proof treatment to the powder magnetic core may be performed as required. The rust-proof treatment may be performed by a known method. For example, a spray coating of epoxy resin, etc., is applied. The thickness of the spray coating is normally around several tens of micrometers. Preferably, heat treatment is performed after the rust-proof treatment.

The invention has been described regarding one preferred embodiment; however, the invention is not limited to the above embodiment. The invention can be modified in various ways without departing from the gist of the invention.

### EXAMPLES

Next, the invention is described in more detail with reference to Examples, but the invention is not limited to those Examples.

In the below Examples and Comparative Examples, various properties were measured in the following manner.

### <Particle Diameter of Primary Particles>

Iron powder was observed using a scanning electron microscope (SEM), and 200 primary particles were randomly selected and measured for their Heywood diameter. The resulting number average particle diameter was used as the particle diameter of the primary particles.

### <D90% Particle Diameter of Secondary Particles>

The D90% particle diameter of the secondary particles of the iron powder was measured using a laser diffraction dry particle size analyzer (HELLS System, Sympatec GmbH).

### <Phosphorus Content>

The weight ratio of phosphorus in the iron powder was obtained by quantitative analysis using an ICP mass spectrometry (ICP-MS).

### <Core Loss of Powder Magnetic Core>

The core loss (magnetic core loss: Pcv) of a powder magnetic core was measured using a BH analyzer (SY-8232, Iwatsu Test Instruments Corporation), under the conditions of: applied magnetic field Bm=25 mT; and f=100 kHz−2 MHz. If the core loss was too large to be measured at 2 MHz, the value obtained by extrapolating the core loss-frequency correlation in the range of 100 kHz−1 MHz was used as the core loss value. If the core loss was particularly large and not measured at 1 MHz, such a core loss was treated as “unmeasurable.”

### <Ratio of 2 MHz Core Loss to 100 kHz Core Loss (Frequency-Dependence of Core Loss)>

The ratio was obtained by dividing a 2 MHz core loss by a 100 kHz core loss. The obtained core loss frequency-dependence shows the rate of increase of core loss relative to the increase of frequency. The higher the value is, the larger the core loss in the range of high frequencies is, so such a powder magnetic core is considered unsuitable for use in high frequencies.

### Comparative Example 1

First, a stainless steel container was filled with hematite (CSR-900, Chemirite, Ltd.) as raw material iron oxide, and the stainless steel container was charged in a box-shaped batch furnace.

Next, the air inside the system was removed using a vacuum pump, and after that, hydrogen gas was introduced at a rate of 1 L/min to replace the inside of the furnace with a positive pressure (1 atm or higher) hydrogen atmosphere. In this state, heating treatment was carried out at a temperature of 600° C. for 5 hours. After the furnace was cooled down to 100° C. or lower, the hydrogen gas inside the furnace was removed, and instead, argon gas and air were introduced to replace the inside of the furnace with an atmosphere having a 2% oxygen partial pressure. In this state, the furnace was held at a temperature of 60-80° C. for 15 minutes, to cause moderate surface oxidation. After that, the stainless steel container was taken out of the furnace, and as a result, reduced iron powder of Comparative Example 1 was obtained. When observing the reduced iron powder of Comparative Example 1 with SEM, the primary particle diameter was in the range of 200-300 nm.

After that, a toroidal mold having an outer diameter of 11.0 mm, an inner diameter of 6.5 mm and a thickness of 3.0 mm was filled with the reduced iron powder of Comparative Example 1, and the reduced iron powder was pressed at a pressure of 6 tonf/cm² to obtain a toroidal compact. The obtained toroidal compact was thereafter charged in a thermostatic chamber and held at 180° C. for one hour to obtain a powder magnetic core of Comparative Example 1.

### Comparative Example 2

5 g of the reduced iron powder of Comparative Example 1 was charged in a 250 ml polyethylene bottle, to which 50 g of steel balls (Φ3.2 mm, 0.16 g/pc) and 20 g of solvent (acetone) were added. After that, disintegration treatment was carried out in an Ar atmosphere for 6 hours using a uniaxial ball mill. The reduced iron powder after the disintegration treatment was taken out, separated from the steel balls with a 2 mm mesh sieve, and heated to evaporate acetone and dried, thereby obtaining (disintegrated) reduced iron powder of Comparative Example 2. When observing the reduced iron powder of Comparative Example 2 with SEM, the primary particle diameter was in the range of 200-300 nm.

In the same manner as Comparative Example 1 other than using the obtained reduced iron powder of Comparative Example 2, a powder magnetic core of Comparative Example 2 was obtained.

### Example 1

5 g of the reduced iron powder of Comparative Example 1 was charged in a 250 ml polyethylene bottle, to which 50 g of steel balls (Φ3.2 mm, 0.16 μg/pc) and 20 g of acetone (reagent, 99%) were added, and phosphoric acid (reagent, 89%) was further added so that the phosphoric acid was 1.00% by weight relative to the weight of the reduced iron powder. After that, disintegration treatment and surface treatment were carried out for 6 hours using a uniaxial ball mill. The reduced iron powder after the disintegration treatment and surface treatment was taken out, separated from the steel balls with a 2 mm mesh sieve, and heated to evaporate acetone and dried, thereby obtaining (disintegrated/surface-treated) reduced iron powder of Example 1. When observing the reduced iron powder of Example 1 with SEM, the primary particle diameter was in the range of 200-300 nm.

In the same manner as Comparative Example 1 other than using the obtained reduced iron powder of Example 1, a powder magnetic core of Example 1 was obtained.

### Example 2

In the same manner as Example 1 other than adding phosphoric acid to be 1.50% by weight relative to the weight of the reduced iron powder, (disintegrated/surface-treated) reduced iron powder of Example 2 and a powder magnetic core of Example 2 were obtained.

### Example 3

In the same manner as Example 1 other than adding phosphoric acid to be 2.00% by weight relative to the weight of the reduced iron powder, (disintegrated/surface-treated) reduced iron powder of Example 3 and a powder magnetic core of Example 3 were obtained.

Table 1 shows the evaluation of the properties of the powder magnetic cores of Examples 1-3 and Comparative Examples 1-2.

TABLE 1

| | | | | | | Surface-treated | |
|---|---|---|---|---|---|---|---|
| | | | | | | Reduced Iron | |
| | | | | | | Powder | |
| | | | | | | | Secondary |
| | | | | | | | Particle |
| | | Treatment of Reduced Iron Powder | | | | Primary | D90% |
| | | | Surface Treatment | | | Particle | Particle |
| | Reduction of Iron | Disintegration | | | Added | Diameter | Diameter |
| | Oxide | Yes/No | Yes/No | Agent | Amount | [nm] | [μm] |
| Comp. Ex. 1 | 600° C. × 5 h, followed | No | No | — | — | 100-500 | 150 |
| | by slow oxidation | | | | | | |
| Comp. Ex. 2 | 600° C. × 5 h, followed | Yes | No | — | — | 100-500 | 6 |
| | by slow oxidation | | | | | | |
| Ex. 1 | 600° C. × 5 h, followed | Yes | Yes | Phosphoric | 1.00 wt % | 100-500 | 6 |
| | by slow oxidation | | | acid | | | |
| Ex. 2 | 600° C. × 5 h, followed | Yes | Yes | Phosphoric | 1.50 wt % | 100-500 | 6 |
| | by slow oxidation | | | acid | | | |
| Ex. 3 | 600° C. × 5 h, followed | Yes | Yes | Phosphoric | 2.00 wt % | 100-500 | 6 |
| | by slow oxidation | | | acid | | | |

| | Surface-treated | | | | | |
|---|---|---|---|---|---|---|
| | Reduced Iron | Pressing | | | | |
| | Powder | | Added | Core Loss of Powder Magnetic Core | | |
| | P content | Addition | Amount | 100 kHz | 2 MHz | |
| | [ppm] | of Resin | [w %] | [kW/m³] | [kW/m³] | 100 kHz/2 MHz |
| Comp. Ex. 1 | 20 | No | 0 | 2090 | un- | — |
| | | | | | measurable | |
| Comp. Ex. 2 | 20 | No | 0 | 343 | 216054 | 618 |
| Ex. 1 | 2830 | No | 0 | 98 | 4928 | 50 |
| Ex. 2 | 4220 | No | 0 | 100 | 2981 | 30 |
| Ex. 3 | 5600 | No | 0 | 119 | 3349 | 28 |

As is clear from Table 1, it was found that the powder magnetic cores of Comparative Examples 1-2 had extremely large core loss and were unsuitable for practical use. On the other hand, it was found that the powder magnetic cores of Examples 1-3 had a 100 kHz core loss of 150 kW/m³ or less and a 2 MHz core loss of 6500 kW/m³ or less and thus were suitable for high-frequency drive at several MHz. In other words, it was found that the powder magnetic cores of Examples 1-3 were able to achieve the object of the invention.

### Comparative Example 3

An epoxy resin (N-695, DIC Corporation (former name: Dainippon Ink and Chemicals, Inc.)) and a curing agent were mixed, and the obtained mixture was dissolved in acetone to prepare a liquid composition. The reduced iron powder of Comparative Example 1 and the liquid composition were introduced into a polyethylene bottle, the liquid composition being weighed so that the total weight of the mixture was 3.0% by weight relative to the weight of the (disintegrated/surface-treated) reduced iron powder. After being stirred and mixed sufficiently while being rotated on a ball mill table, the resulting product was taken out into a beaker, and heated to evaporate acetone and dried, thereby obtaining reduced iron powder of Comparative Example 3 in the form of granules.

In the same manner as Comparative Example 1 other than using the obtained reduced iron powder of Comparative Example 3, a toroidal compact was obtained. After that, the obtained toroidal compact was charged in a thermostatic chamber and held at 180° C. for one hour to cure resin, thereby obtaining a powder magnetic core of Comparative Example 3.

### Comparative Example 4

In the same manner as Comparative Example 3 other than using the reduced iron powder of Comparative Example 2, (disintegrated) reduced iron powder of Comparative Example 4 in the form of granules, and a powder magnetic core of Comparative Example 4 were obtained.

### Comparative Example 5

In the same manner as Example 1 other than adding phosphoric acid to be 0.05% by weight relative to the weight of the reduced iron powder, (disintegrated/surface-treated) reduced iron powder was obtained.

In the same manner as Comparative Example 3 other than using the obtained (disintegrated/surface-treated) reduced iron powder, (disintegrated/surface-treated) reduced iron powder of Comparative Example 5 in the form of granules was obtained.

In the same manner as Comparative Example 3 other than using the obtained (disintegrated/surface-treated) reduced iron powder of Comparative Example 5, a powder magnetic core of Comparative Example 5 was obtained.

### Comparative Example 6

In the same manner as Example 1 other than adding phosphoric acid to be 0.10% by weight relative to the weight of the reduced iron powder, (disintegrated/surface-treated) reduced iron powder was obtained.

In the same manner as Comparative Example 3 other than using the obtained (disintegrated/surface-treated) reduced iron powder, (disintegrated/surface-treated) reduced iron powder of Comparative Example 6 in the form of granules was obtained.

In the same manner as Comparative Example 3 other than using the obtained (disintegrated/surface-treated) reduced iron powder of Comparative Example 6, a powder magnetic core of Comparative Example 6 was obtained.

### Example 4

In the same manner as Example 1 other than adding phosphoric acid to be 0.20% by weight relative to the weight of the reduced iron powder, (disintegrated/surface-treated) reduced iron powder was obtained.

In the same manner as Comparative Example 3 other than using the obtained (disintegrated/surface-treated) reduced iron powder, (disintegrated/surface-treated) reduced iron powder of Example 4 in the form of granules was obtained.

In the same manner as Comparative Example 3 other than using the obtained (disintegrated/surface-treated) reduced iron powder of Example 4, a powder magnetic core of Example 4 was obtained.

### Example 5

In the same manner as Example 1 other than adding phosphoric acid to be 0.40% by weight relative to the weight of the reduced iron powder, (disintegrated/surface-treated) reduced iron powder was obtained.

In the same manner as Comparative Example 3 other than using the obtained (disintegrated/surface-treated) reduced iron powder, (disintegrated/surface-treated) reduced iron powder of Example 5 in the form of granules was obtained.

In the same manner as Comparative Example 3 other than using the obtained (disintegrated/surface-treated) reduced iron powder of Example 5, a powder magnetic core of Example 5 was obtained.

### Example 6

In the same manner as Example 1 other than adding phosphoric acid to be 1.00% by weight relative to the weight of the reduced iron powder, (disintegrated/surface-treated) reduced iron powder was obtained.

In the same manner as Comparative Example 3 other than using the obtained (disintegrated/surface-treated) reduced iron powder, (disintegrated/surface-treated) reduced iron powder of Example 6 in the form of granules was obtained.

In the same manner as Comparative Example 3 other than using the obtained (disintegrated/surface-treated) reduced iron powder of Example 6, a powder magnetic core of Example 6 was obtained.

### Example 7

In the same manner as Example 1 other than adding phosphoric acid to be 2.00% by weight relative to the weight of the reduced iron powder, (disintegrated/surface-treated) reduced iron powder was obtained.

In the same manner as Comparative Example 3 other than using the obtained (disintegrated/surface-treated) reduced iron powder, (disintegrated/surface-treated) reduced iron powder of Example 7 in the form of granules was obtained.

In the same manner as Comparative Example 3 other than using the obtained (disintegrated/surface-treated) reduced iron powder of Example 7, a powder magnetic core of Example 7 was obtained.

### Comparative Example 7

In the same manner as Example 1 other than adding phosphoric acid to be 5.00% by weight relative to the weight of the reduced iron powder, (disintegrated/surface-treated) reduced iron powder was obtained.

In the same manner as Comparative Example 3 other than using the obtained (disintegrated/surface-treated) reduced iron powder, (disintegrated/surface-treated) reduced iron powder of Comparative Example 7 in the form of granules was obtained.

In the same manner as Comparative Example 3 other than using the obtained (disintegrated/surface-treated) reduced iron powder of Comparative Example 7, a powder magnetic core of Comparative Example 7 was obtained.

### Comparative Example 8

In the same manner as Example 1 other than not adding steel balls, (surface-treated) reduced iron powder was obtained.

In the same manner as Comparative Example 3 other than using the obtained (surface-treated) reduced iron powder, (surface-treated) reduced iron powder of Comparative Example 8 in the form of granules was obtained.

Using the obtained (surface-treated) reduced iron powder of Comparative Example 8, and other than that, in the same manner as Comparative Example 3, a powder magnetic core of Comparative Example 8 was obtained.

### Comparative Example 9

In the same manner as Example 6 other than using hydrochloric acid (reagent, min 35%, Junsei Chemical Co., Ltd. Extra pure grade) instead of phosphoric acid, (disintegrated/surface-treated) reduced iron powder of Comparative Example 9 in the form of granules, and a powder magnetic core of Comparative Example 9 were obtained.

### Comparative Example 10

In the same manner as Example 6 other than using acetic acid (reagent, min 99.7%, guaranteed grade) instead of phosphoric acid, (disintegrated/surface-treated) reduced iron powder of Comparative Example 10 in the form of granules, and a powder magnetic core of Comparative Example 10 were obtained.

Table 2 shows the evaluation of the properties of the reduced iron powder and powder magnetic cores of Examples 4-7 and Comparative Examples 3-10.

TABLE 2

| | | | | | | Surface-treated | |
|---|---|---|---|---|---|---|---|
| | | | | | | Reduced Iron Powder | |
| | | | | | | | Secondary |
| | | Treatment of Reduced Iron Powder | | | | Primary | Particle D90% |
| | | | Surface Treatment | | | Particle | Particle |
| | Reduction of Iron | Disintegration | | | Added | Diameter | Diameter |
| | Oxide | Yes/No | Yes/No | Agent | Amount | [nm] | [μm] |
| Comp. Ex. 3 | 600° C. × 5 h, followed | No | No | — | — | 100-500 | 150 |
| | by slow oxidation | | | | | | |
| Comp. Ex. 4 | 600° C. × 5 h, followed | Yes | No | — | — | 100-500 | 6 |
| | by slow oxidation | | | | | | |
| Comp. Ex. 5 | 600° C. × 5 h, followed | Yes | Yes | Phosphoric | 0.05 | 100-500 | 6 |
| | by slow oxidation | | | acid | | | |
| Comp. Ex. 6 | 600° C. × 5 h, followed | Yes | Yes | Phosphoric | 0.10 | 100-500 | 6 |
| | by slow oxidation | | | acid | | | |
| Ex. 4 | 600° C. × 5 h, followed | Yes | Yes | Phosphoric | 0.20 | 100-500 | 6 |
| | by slow oxidation | | | acid | | | |
| Ex. 5 | 600° C. × 5 h, followed | Yes | Yes | Phosphoric | 0.40 | 100-500 | 6 |
| | by slow oxidation | | | acid | | | |
| Ex. 6 | 600° C. × 5 h, followed | Yes | Yes | Phosphoric | 1.00 | 100-500 | 6 |
| | by slow oxidation | | | acid | | | |
| Ex. 7 | 600° C. × 5 h, followed | Yes | Yes | Phosphoric | 2.00 | 100-500 | 6 |
| | by slow oxidation | | | acid | | | |
| Comp. Ex. 7 | 600° C. × 5 h, followed | Yes | Yes | Phosphoric | 5.00 | 100-500 | 6 |
| | by slow oxidation | | | acid | | | |
| Comp. Ex. 8 | 600° C. × 5 h, followed | No | Yes | Phosphoric | 1.00 | 100-500 | 150 |
| | by slow oxidation | | | acid | | | |
| Comp. Ex. 9 | 600° C. × 5 h, followed | Yes | Yes | Hydrochloric | 1.00 | 100-500 | 6 |
| | by slow oxidation | | | acid | | | |
| Comp. Ex. 10 | 600° C. × 5 h, followed | Yes | Yes | Acetic acid | 1.00 | 100-500 | 6 |
| | by slow oxidation | | | | | | |

| | Surface-treated | | | | | |
|---|---|---|---|---|---|---|
| | Reduced Iron | Pressing | | | | |
| | Powder | | Added | Core Loss of Powder Magnetic Core | | |
| | P content | Addition | Amount | 100 kHz | 2 MHz | |
| | [ppm] | of Resin | [w %] | [kW/m³] | [kW/m³] | 100 kHz/2 MHz |
| Comp. Ex. 3 | 20 | Epoxy | 3.0 | 392 | 103747 | 271 |
| Comp. Ex. 4 | 20 | Epoxy | 3.0 | 177 | 32958 | 186 |
| Comp. Ex. 5 | 170 | Epoxy | 3.0 | 142 | 13998 | 99 |
| Comp. Ex. 6 | 320 | Epoxy | 3.0 | 126 | 9443 | 75 |
| Ex. 4 | 630 | Epoxy | 3.0 | 109 | 4529 | 42 |
| Ex. 5 | 1260 | Epoxy | 3.0 | 109 | 3335 | 31 |
| Ex. 6 | 2830 | Epoxy | 3.0 | 118 | 3122 | 26 |
| Ex. 7 | 5600 | Epoxy | 3.0 | 123 | 3130 | 25 |
| Comp. Ex. 7 | 15000 | Epoxy | 3.0 | 173 | 4375 | 25 |
| Comp. Ex. 8 | 2830 | Epoxy | 3.0 | 268 | 50078 | 187 |
| Comp. Ex. 9 | 20 | Epoxy | 3.0 | 321 | 9267 | 29 |
| Comp. Ex. 10 | 20 | Epoxy | 3.0 | 197 | 31706 | 161 |

As is clear from Table 2, it was found that the powder magnetic cores of Comparative Examples 3-10 had extremely large core loss and were unsuitable for practical use. On the other hand, it was found that the powder magnetic cores of Examples 4-7 had a 100 kHz core loss of 150 kW/m³ or less and a 2 MHz core loss of 6500 kW/m³ or less and thus were suitable for high-frequency drive at several MHz. In other words, it was found that the powder magnetic cores of Examples 4-7 were able to achieve the object of the invention. In particular, it was found that, in the powder magnetic cores of Examples 4-7 having a phosphorus content of 1000-5000 ppm, the core loss and the frequency-dependence of the core loss were particularly advantageous.

### Comparative Example 11

In the same manner as Comparative Example 4 other than using a silicone resin (SR2414LV, Dow Corning Toray Co., Ltd.) instead of an epoxy resin and using the liquid composition after being weighed so that the total weight of the mixture was 4.0% by weight relative to the weight of the reduced iron powder, (surface-treated) reduced iron powder of Comparative Example 11 in the form of granules, and a powder magnetic core of Comparative Example 11 were obtained.

### Example 8

In the same manner as Example 6 other than: adding phosphoric acid to be 0.50% by weight relative to the weight of the reduced iron powder; using a silicone resin (SR2414LV, Dow Corning Toray Co., Ltd.) instead of an epoxy resin; and using the liquid composition after being weighed so that the total weight of the mixture was 4.0% by weight relative to the weight of the reduced iron powder, (disintegrated/surface-treated) reduced iron powder of Example 8 in the form of granules, and a powder magnetic core of Example 8 were obtained.

### Example 9

In the same manner as Example 8 other than adding phosphoric acid to be 1.00% by weight relative to the weight of the reduced iron powder, (disintegrated/surface-treated) reduced iron powder of Example 9 in the form of granules, and a powder magnetic core of Example 9 were obtained.

### Example 10

In the same manner as Example 8 other than adding phosphoric acid to be 2.00% by weight relative to the weight of the reduced iron powder, (disintegrated/surface-treated) reduced iron powder of Example 10 in the form of granules, and a powder magnetic core of Example 10 were obtained.

Table 3 shows the evaluation of the properties of the reduced iron powder and powder magnetic cores of Examples 8-10 and Comparative Example 11.

TABLE 3

| | | | | | | Surface-treated | |
|---|---|---|---|---|---|---|---|
| | | | | | | Reduced Iron Powder | |
| | | | | | | | Secondary |
| | | Treatment of Reduced Iron Powder | | | | Primary | Particle D90% |
| | | | Surface Treatment | | | Particle | Particle |
| | Reduction of Iron | Disintegration | | | Added | Diameter | Diameter |
| | Oxide | Yes/No | Yes/No | Agent | Amount | [nm] | [μm] |
| Comp. Ex. 11 | 600° C. × 5 h, followed | Yes | No | — | — | 100-500 | 6 |
| | by slow oxidation | | | | | | |
| Ex. 8 | 600° C. × 5 h, followed | Yes | Yes | Phosphoric | 0.50 | 100-500 | 6 |
| | by slow oxidation | | | acid | | | |
| Ex. 9 | 600° C. × 5 h, followed | Yes | Yes | Phosphoric | 1.00 | 100-500 | 6 |
| | by slow oxidation | | | acid | | | |
| Ex. 10 | 600° C. × 5 h, followed | Yes | Yes | Phosphoric | 2.00 | 100-500 | 6 |
| | by slow oxidation | | | acid | | | |

| | Surface-treated | | | | | |
|---|---|---|---|---|---|---|
| | Reduced Iron | Pressing | | | | |
| | Powder | | Added | Core Loss of Powder Magnetic Core | | |
| | P content | Addition | Amount | 100 kHz | 2 MHz | |
| | [ppm] | of Resin | [w %] | [kW/m³] | [kW/m³] | 100 kHz/2 MHz |
| Comp. Ex. 11 | 20 | Silicone | 4.0 | 141 | 6761 | 48 |
| Ex. 8 | 1430 | Silicone | 4.0 | 137 | 3836 | 28 |
| Ex. 9 | 2830 | Silicone | 4.0 | 121 | 3210 | 27 |
| Ex. 10 | 5600 | Silicone | 4.0 | 136 | 3588 | 26 |

As is clear from Table 3, it was found that the powder magnetic core of Comparative Example 11 had a very large 2 MHz core loss and thus was not sufficiently suitable for high-frequency drive. On the other hand, it was found that the powder magnetic cores of Examples 8-10 had a 100 kHz core loss of 150 kW/m³ or less and a 2 MHz core loss of 6500 kW/m³ or less and thus were suitable for high-frequency drive at several MHz. In other words, it was found that the powder magnetic cores of Examples 8-10 were able to achieve the object of the invention.

### Example 11

5 g of the reduced iron powder of Comparative Example 1 was charged in a 250 ml polyethylene bottle, to which 50 g of steel balls (Φ3.2 mm, 0.16 g/pc) and 20 g of acetone (reagent, 99%) were added. After that, disintegration treatment was carried out for 6 hours using a uniaxial ball mill. The reduced iron powder after the disintegration treatment was taken out, separated from the steel balls with a 2 mm mesh sieve, and heated to evaporate acetone and dried.

Next, the obtained disintegrated reduced iron powder was again charged in a 250 ml polyethylene bottle, to which phosphoric acid (reagent, 89%) was added to be 1.00% by weight relative to the weight of the reduced iron powder. After that, surface treatment was carried out for 6 hours using a uniaxial ball mill.

In the same manner as Example 6 other than using the obtained reduced iron powder, namely, the reduced iron powder that had been disintegrated and then surface-treated, (disintegrated/surface-treated) reduced iron powder of Example 11 in the form of granules, and a powder magnetic core of Example 11 were obtained.

### Example 12

5 g of the reduced iron powder of Comparative Example 1 was charged in a 250 ml polyethylene bottle, to which phosphoric acid (reagent, 89%) was added to be 1.00% by weight relative to the weight of the reduced iron powder. After that, surface treatment was carried out for 6 hours using a uniaxial ball mill.

Next, the obtained surface-treated reduced iron powder was again charged in a 250 ml polyethylene bottle, to which 50 g of steel balls (Φ3.2 mm, 0.16 g/pc) and 20 g of acetone (reagent, 99%) were added. After that, disintegration treatment was carried out for 6 hours using a uniaxial ball mill. The reduced iron powder after the disintegration treatment was taken out, separated from the steel balls with a 2 mm mesh sieve, and heated to evaporate acetone and dried.

In the same manner as Example 6 other than using the obtained reduced iron powder, namely, the reduced iron powder that had been surface-treated and then disintegrated, (disintegrated/surface-treated) reduced iron powder of Example 12 in the form of granules, and a powder magnetic core of Example 12 were obtained.

Table 4 shows the evaluation of the properties of the reduced iron powder and powder magnetic cores of Examples 6, 11 and 12.

TABLE 4

| | | Core Loss of Powder | | |
|---|---|---|---|---|
| | | Magnetic Core | | |
| | Treatment of Reduced | 100 kHz | 2 MHz | 100 kHz/ |
| | Iron Powder | [kW/m³] | [kW/m³] | 2 MHz |
| Ex. 6 | Disintegration and surface | 118 | 3122 | 26 |
| | treatment at the same time | | | |
| Ex. 11 | Disintegration, followed by | 121 | 3285 | 27 |
| | surface treatment | | | |
| Ex. 12 | Surface treatment, followed | 121 | 6184 | 51 |
| | by disintegration | | | |

As is clear from Table 4, it was found that the powder magnetic cores of Examples 6, 11 and 12 had a 100 kHz core loss of 150 kW/m³ or less and a 2 MHz core loss of 6500 kW/m³ or less and thus were suitable for high-frequency drive at several MHz. In other words, it was found that the powder magnetic cores of Examples 6, 11 and 12 were able to achieve the object of the invention. In particular, the powder magnetic core of Example 6 obtained by carrying out the disintegration treatment and the surface treatment at the same time, and the powder magnetic core of Example 11 obtained by carrying out the disintegration treatment first and the surface treatment later, were found advantageous in terms of core loss and frequency-dependence of the core loss, relative to the powder magnetic core of Example 12 obtained by carrying out the surface treatment first and the disintegration treatment later.

### Reference Example 1

In the same manner as Example 6 other than replacing the steel balls (Φ3.2 mm, 0.16 g/pc) with steel balls (12.7 mm, 8 g/pc), (disintegrated/surface-treated) reduced iron powder of Reference Example 1 in the form of granules, and a powder magnetic core of Reference Example 1 were obtained.

Table 5 shows the evaluation of the properties of the reduced iron powder and powder magnetic cores of Example 6 and Reference Example 1.

TABLE 5

| | | Core Loss of Powder | | |
|---|---|---|---|---|
| | | Magnetic Core | | |
| | | 100 kHz | 2 MHz | 100 kHz/ |
| | Disintegration Media | [kW/m³] | [kW/m³] | 2 MHz |
| Ex. 6 | Steel 3.2 mm, 0.16 g/pc | 118 | 3122 | 26 |
| Ref. Ex. 1 | Steel 12.7 mm, 8 g/pc | 153 | 6155 | 40 |

As is clear from Table 5, when comparing Example 6 and Reference Example 1, it was found that the powder magnetic core of Example 6, in which the reduced iron powder was disintegrated using media, each weighing 6 g or less, had a 100 kHz core loss of 150 kW/m³ or less and a 2 MHz core loss of 6500 kW/m³ and thus was suitable for high-frequency drive at several MHz, and was particularly advantageous in terms of core loss and frequency-dependence of the core loss; whereas, it was found that the powder magnetic core of Reference Example 1, in which the reduced iron powder was disintegrated using media, each weighing more than 6 g, had large core loss particularly in low frequencies. This suggests that disintegrating the reduced iron powder using media, each weighing more than 6 g, causes the deformation of the primary particles, which would result in an increase of the hysteresis loss and a consequent increase of the core loss.

### <Observation of Surfaces>

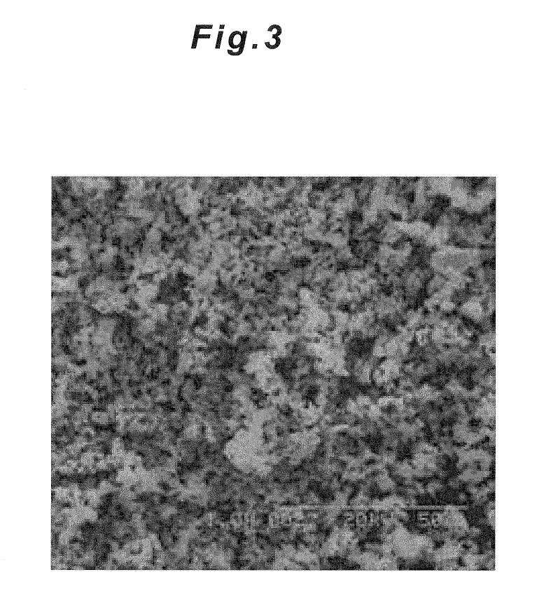

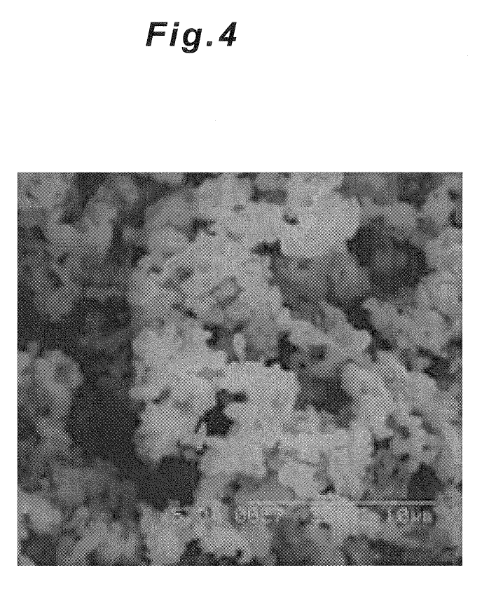

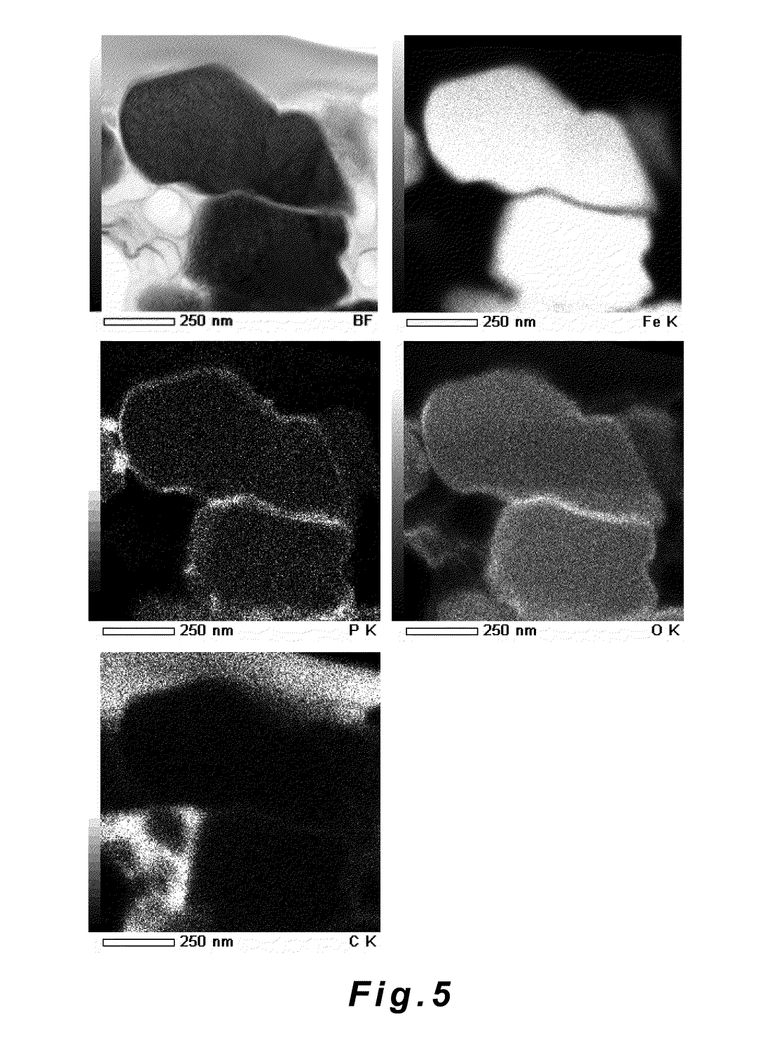

FIGS. 3 and 4 are SEM photographs of the (disintegrated/surface-treated) reduced iron powder of Example 1. Also, the (disintegrated/surface-treated) reduced iron powder of Example 1 was embedded in resin, and the resulting product was processed to be about 100 nm thick, and observed with a transmission electron microscope (TEM). Furthermore, STEM-EDS analysis was carried out using an energy dispersive X-ray analyzer for the portion near the surface of the reduced iron powder, to obtain Fe-, P- and O-concentration profiles. The results of the analysis are shown in FIG. 5.

As is clear from FIG. 3, about 1-2 μm iron particles (secondary particles) were observed, and only Fe was detected inside the iron particles, while Fe, P and O were detected on the surface. This demonstrates that the iron particles had on the surface thereof a coating of a compound containing mainly Fe, P and O (e.g., iron phosphate, iron oxide such as FeO, Fe₂O₃, or Fe₃O₄). The above coating of the compound was about 10 nm thick. According to the above, it is believed that since a thin coating of a compound containing mainly Fe, P and O (e.g., iron phosphate, iron oxide such as FeO, Fe₂O₃, Fe₃O₄) was formed on the surface of the iron particles, a high level of insulating properties was obtained and the eddy current loss was reduced.

### Examples 1-12 and Comparative Examples 1-11 Demonstrated the Following

By carrying out the surface treatment with phosphoric acid, in addition to the disintegration treatment, core loss and frequency-dependence of the core loss were greatly improved. In particular, core loss at 2 MHz was extremely improved. This is believed to be because eddy current loss was reduced as a result of the above-explained insulating ability of phosphoric acid. In addition, the small frequency-dependence of the core loss suggests that the loss at high frequencies of 2 MHz or more would also be small.

The Examples also demonstrated that the core loss and the frequency-dependence of the core loss were likely to be smaller with the addition of resin to the reduced iron powder. Note, however, that when at least one of the disintegration treatment and the surface treatment using phosphoric acid was not performed, sufficient effects were not obtained even if adding resin to the reduced iron powder and pressing it, probably because the surface area of the reduced iron powder were so large or the coating was not sufficient.

The Examples also confirmed that the D90% particle diameter of the secondary particles was able to be reduced to 20 μm or less by the disintegration treatment and the core loss and the frequency-dependence of the core loss were accordingly reduced. The Examples also confirmed that the primary particle diameter was in the range of 200-300 nm both before and after the disintegration treatment and it varied little before and after the disintegration treatment. This suggests that the major effect of the disintegration treatment is the capability of reducing the secondary particle D90% diameter to 20 μm or less and that this effect leads to the miniaturization of the primary and secondary particles and the consequently reduced eddy current loss.

The Examples also confirmed that the core loss and the frequency-dependence of the core loss were reduced by the surface treatment using phosphoric acid. The Examples demonstrated, however, that the surface treatment using phosphoric acid alone brought insufficient results. This is believed to be because the large secondary particle diameter of the reduced iron powder made it impossible to sufficiently reduce the area where eddy current can flow.

The Examples also demonstrated that when the phosphorus content was less than 0.15% by weight relative to the weight of the reduced iron powder, the core loss at 2 MHz was large and the frequency-dependence of the core loss was also large. This is believed to be because the phosphorus content was too small to form an insulating layer having a sufficient thickness, or to form an insulating layer evenly, resulting in the insufficient reduction of eddy current.

On the other hand, when the phosphorus content was more than 4.0% relative to the weight of the reduced iron powder, the core loss at 100 kHz was large. This is believed to be because the excess amount of phosphoric acid probably dissolved not only the surface oxidation layer but also the internal metal iron of the reduced iron powder, which produced magnetic adverse effects to increase the hysteresis loss.

The Examples also demonstrated that the frequency-dependence of the core loss was also able to be reduced by the surface treatment using hydrochloric acid instead of phosphoric acid. Since hydrochloric acid can dissolve iron oxide, it is believed that the surface oxidation layer of the reduced iron powder was dissolved or removed by hydrochloric acid, which resulted in the improved frequency-dependence of the core loss. Note, however, that the surface treatment using hydrochloric acid was not able to reduce the core loss to a sufficient level, probably because the formed iron chloride can facilitate the generation of rust or affect metal iron itself. The above suggests that adjusting the surface treatment conditions is not easy in the surface treatment using hydrochloric acid.

The Examples also demonstrated that the core loss and the frequency-dependence of the core loss were barely affected when carrying out the surface treatment using acetic acid instead of phosphoric acid. This is believed to be because acetic acid is mild acid, cannot dissolve iron oxide, and thus cannot remove the surface oxidation layer of the reduced iron powder.

The phosphorus content in the surface-treated reduced iron powder was substantially the same as the amount added at the time of the surface treatment with phosphoric acid. This shows that the majority of the added phosphoric acid remained in the surface-treated reduced iron powder and that the surface of the reduced iron powder was coated with phosphorus or phosphorus compounds.

As described above, the surface-treated reduced iron powder and a method for manufacturing the same, and the powder magnetic core of the invention, can greatly reduce core loss in the range of high frequencies as well as low frequencies, and are applicable to high frequencies of 1 MHz or more, and can thus achieve downsizing: Accordingly, the invention can be widely and effectively used for electric/magnetic devices such as inductors, various transformers, magnetic shielding materials, etc., and various types of appliances, equipment, systems, etc., provided with such electric/magnetic devices.

1. Surface-treated reduced iron powder obtained by at least surface-treating reduced iron powder prepared by a reduction and slow oxidation method, the surface-treated reduced iron powder comprising:
secondary particles formed through agglomeration of primary particles having an average particle diameter of 0.01-5 um, wherein:
the secondary particles have a D90% particle diameter of 20 μm or less;
the surface of the primary particles is at least in part coated with an insulating layer comprising iron phosphate; and
a phosphorus content is 500-10000 ppm.

2. The surface-treated reduced iron powder according to claim 1,
obtained by disintegrating the reduced iron powder and surface-treating the reduced iron powder using phosphoric acid.

3. The surface-treated reduced iron powder according to claim 1,
further comprising insulating resin.

4. The surface-treated reduced iron powder according to claim 2,
further comprising insulating resin.

5. A powder magnetic core obtained by pressing the surface-treated reduced iron powder according to claim 1.

6. A method for manufacturing surface-treated reduced iron powder, comprising the steps of:
preparing reduced iron powder by a reduction and slow oxidation method, the reduced iron powder comprising primary particles having an average particle diameter of 0.01-5 μm;
disintegrating the reduced iron powder; and
surface-treating the reduced iron powder using 0.15-4.00% by weight of phosphoric acid relative to the weight of the reduced iron powder.

7. The method for manufacturing the surface-treated reduced iron powder according to claim 6,
wherein the disintegrating step and the surface-treating step using phosphoric acid are carried out at the same time, or the surface-treating step using phosphoric acid is carried out after the disintegrating step.

8. The method for manufacturing the surface-treated reduced iron powder according to claim 6,
wherein, in the step of preparing reduced iron powder, the reduced iron powder is obtained by carrying out reduction in a reducing atmosphere and thereafter carrying out slow oxidation in an oxidizing atmosphere.

9. The method for manufacturing the surface-treated reduced iron powder according to claim 7,
wherein, in the step of preparing reduced iron powder, the reduced iron powder is obtained by carrying out reduction in a reducing atmosphere and thereafter carrying out slow oxidation in an oxidizing atmosphere.

10. The method for manufacturing the surface-treated reduced iron powder according to claim 6,
wherein, in the disintegrating step, the reduced iron powder is disintegrated using media, each having a weight of 6 g or less.

11. The method for manufacturing the surface-treated reduced iron powder according to claim 7,
wherein, in the disintegrating step, the reduced iron powder is disintegrated using media, each having a weight of 6 g or less.

12. The method for manufacturing the surface-treated reduced iron powder according to claim 8,
wherein, in the disintegrating step, the reduced iron powder is disintegrated using media, each having a weight of 6 g or less.

13. The method for manufacturing the surface-treated reduced iron powder according to claim 9,
wherein, in the disintegrating step, the reduced iron powder is disintegrated using media, each having a weight of 6 g or less.

14. The method for manufacturing the surface-treated reduced iron powder according to claim 6,
further comprising a step of adding insulating resin to the reduced iron powder after the surface treatment.

15. Surface-treated reduced iron powder obtained by disintegrating reduced iron powder prepared by a reduction and slow oxidation method and surface-treating the reduced iron powder using phosphoric acid, the surface-treated reduced iron powder comprising:
secondary particles formed through agglomeration of primary particles having an average particle diameter of 0.01-5 μm, wherein:
the secondary particles have a D90% particle diameter of 20 μm or less; and
a phosphorus content is 500-10000 ppm.

16. The surface-treated reduced iron powder according to claim 15,
wherein the secondary particles include on the surface thereof P, O and Fe.
